(19) United States
(12) Patent Application Publication
(10) Pub. No.: US 2026/0225871 A1
(43) Pub. Date: Aug. 6, 2026

(54) Module for a Container Treatment Machine

(71) Applicant: Krones AG, Neutraubling (DE)

(72) Inventors: Franz WEIGL, Pfakofen (DE); Thorsten GUT, Neutraubling (DE); Stefan SCHOBER, Tegernheim (DE)

(21) Appl. No.: 19/463,892

(22) Filed: Jan. 29, 2026

(30) Foreign Application Priority Data
Jan. 31, 2025 (DE) 102025103568.7

(51) Int. Cl. B67C 3/00; B67C 7/00

(52) U.S. Cl. CPC B67C 3/007; B67C 3/008; B67C 7/00

(57) ABSTRACT

A module for a container treatment machine includes a frame, a container inspection device and a container discharge device downstream of the inspection device. The inspection device and the discharge device are fastened to the frame in a well-defined relative arrangement.

### CROSS-REFERENCE TO RELATED APPLICATIONS

This application claims priority to, and the benefit of, German Patent Application No. 102025103568.7, filed January 31, 2025, the contents of which are incorporated by reference herein in their entirety.

### TECHNICAL FIELD

The present invention relates to a module for a container treatment machine.

### BACKGROUND

Container treatment machines are generally known from the prior art. Container treatment machines usually comprise a plurality of components and must first be assembled and set up by the manufacturer. Afterwards, transport to the customer is usually required. This may require disassembling the already assembled machines again, which disadvantageously means that the customer has to set it back up, or makes it necessary to ensure that the components are reliably arranged relative to one another and can perform their intended function.

DE 102010043635 A1 discloses an apparatus for inspecting containers or the like, in particular bottles made of glass or plastics material, with an inspection module mounted on a conveying path, wherein the apparatus is configured as a modular inspection unit comprising a carrier having receiving positions for a plurality of inspection modules.

From EP 1449778 A1, an inspection module with various components, in particular sensors, is known.

US 6,525,333 B1 further discloses a system and a method for inspecting an object having an annular opening, such as a container or can, and uses a plurality of cameras that capture grayscale images of arcuate sectors that collectively form a circular region within the opening. A processor is connected to the plurality of cameras to receive the grayscale images and to detect defects within the container on the basis of contrast differences and grayscale intensity. This allows intelligent analysis of defects through qualitative inspections and quantitative measurements at higher speeds.

At the same time, the fact that other components, such as control cabinets or transport devices, can in principle be arranged in any way makes it difficult to reliably arrange components of a container treatment machine so as to save space.

### BRIEF SUMMARY

Aspects of the invention relate to a module for a container treatment machine that reduces the setup effort and at the same time saves as much space as possible.

According to one aspect of the invention, a module for a container treatment machine is provided, the module comprising a frame, a container inspection device and a container discharge device downstream of the inspection device, wherein the inspection device and the discharge device are fastened to the frame in a well-defined relative arrangement.

The frame can be made of one piece or of several pieces (i.e., comprising multiple parts). Within the context of the invention, the defined arrangement of the inspection device and the discharge device is understood to be an arrangement of the inspection device and the discharge device that is determined, for example during setup or initial assembly of the module, comprising the frame, the inspection device and the discharge device, in order to ensure the functionality of the module. The well-defined arrangement is therefore the arrangement in which the inspection device and the discharge device are arranged on the frame in such a way that they can perform their intended function as flawlessly as possible.

The container treatment machine can, in particular, be a container treatment machine for treating cans. In this respect, it may be provided that the inspection device is configured to inspect cans (in particular empty cans) and the discharge device is configured to discharge these cans (in particular also empty cans).

However, the invention is not limited with regard to the suitability or configuration of the inspection device and the discharge device.

Advantageously, though not necessarily, the module can also comprise a media supply (in particularly permanently) arranged on the frame, with which a vacuum can be applied to a vacuum conveyor belt for transporting containers (which belt does not have to be permanently installed on the frame).

This module reduces the effort required to set up the components, i.e., the inspection device and the discharge device, as the customer no longer has to set it up again. At the same time, space can be saved by systematically arranging the components on the frame.

An expulsion monitoring process can take place after the expulsion element.

It may be provided that the inspection device and/or the discharge device are permanently or detachably fastened to the frame.

This can be particularly advantageous if the module needs to be re-disassembled into its components for subsequent transportation, in particular if the inspection device and/or the discharge device need to be detached from the frame. The well-defined arrangement can be noted, in particular by markings on the frame or by connecting elements such as receiving or centering mandrels that remain fastened to the frame and screw connections for fastening the inspection device and/or the discharge device be predefined so that when reassembling, the same alignment can be achieved without having to completely readjust the relative position of the inspection device and the discharge device.

Preferably, both the inspection device and the discharge device are, however, permanently arranged on the frame, in particular so that they cannot be removed without being damaged or without the use of tools.

In one embodiment it can be provided that the frame comprises support elements for placing down the module. It may be provided that the support elements can ensure a bottom clearance of the module of, for example, up to 500 mm, up to 400 mm, or up to 300 mm.

In one embodiment it can be provided that a vacuum conveyor can be used as a transport element to guide the containers past the inspection modules.

The support elements can be, for example, feet (for example with a non-slip and abrasion-resistant surface to improve the stability of the module on the floor of a workshop), so that it is possible to place down the frame and thus the module on, for example, the floor of a workshop.

The support elements can be configured in particular in such a way that the alignment of the frame can be adjusted so that it can be adapted, for example, to a surface that is not perfectly level in order to ensure that the module is reliably supported.

The frame may comprise a through-opening for the passage of containers from the discharge device.

These through-openings allow containers, for example, to be transported through the discharge device so as not to transport them further. Said containers can be discharged, for example, if the inspection device determines that a particular container is defective. This embodiment can save further space while simultaneously ensuring reliable discharge of the containers.

It can be provided that the module may comprise an electrical or electronic component for controlling the inspection device and/or the discharge device. The electrical or electronic component can, for example, be a switching cabinet with control electronics and/or comprise a power supply for at least the inspection device and/or the discharge device. For example, evaluation electronics required for the inspection device (e.g., comprising any type of image evaluation for images of containers taken by the inspection device) can also be provided as an electronic component in a switching cabinet, for example. This switching cabinet, or a separate electronic component, may also comprise control electronics for the discharge device. The control electronics can, for example, be configured to track an inspected container (e.g., during transport of the container by means of a vacuum conveyor belt using corresponding information from the rotary encoder) and to control the discharge device (e.g., a discharge element such as a pusher or a drive means of the discharge element) to discharge the container on the basis of its position and the result of its inspection. This further compacts the module, allowing the advantages of the invention to be achieved.

The electrical or electronic component can be fastened to the frame in a well-defined position. This can reduce any need for subsequent setup, for example, by those purchasing the module.

In one embodiment, it is provided that the frame comprises a connecting element for connecting the frame to another component of the container treatment machine. This embodiment also allows for more complex container treatment plants with reduced setup effort, in particular for those purchasing the plant.

The connecting element can be configured to adjust a relative arrangement of the module to the component.

Despite simplified setup, this embodiment allows any deviations in the nature of a region intended for placing down the module to be taken into account.

The module’s dimensions allow it to be transported in an ISO container.

This means, in particular, that the module, in its assembled state, has dimensions that allow the entire module to be placed in an ISO container when assembled without getting damaged. This further reduces the setup effort for those purchasing the module, as the entire module can be delivered as a unit, which can completely or largely eliminate the need for the customer to re-setup the module.

It may be provided that the frame comprises transport receiver for receiving transport elements of a transport device.

The transport receivers can, for example, be openings for receiving or inserting forklift grippers or forks. In this sense, the transport device is a transport device for transporting the module itself. This makes the module even more compact and easy to transport.

In one embodiment it can be provided that the module comprises at least one of a second inspection device, a transport device for transporting containers, and a marking device for marking containers in a well-defined arrangement relative to the inspection device and/or the discharge device. As already described, the containers can be, in particular, cans, so the described devices can be configured in particular to interact with cans (inspecting, discharging, transporting, marking).

Other or additional devices are also conceivable. In particular, an empty can inspection device may be provided as a second inspection device (or also as an inspection device) for inspecting empty cans or part of the cans. For example, the empty can inspection device can be configured to inspect a can flange, an inner can wall, a can side wall, or a foil in or on the bottom of the can. Side wall inspection can in particular also comprise checking imprints (such as dates or country codes, test can recognition, color recognition, matrix codes) or decorative elements (printed images, labels, etc. that are applied).

The marking device may be configured in particular to apply a date or similar information associated with the manufacture of the container (in particular the can) to part of the surface (such as part of the side wall or the bottom) of the container. The marking device can be configured, for example, as a direct print head or as a laser marking device. The marking device may also comprise a monitoring device for monitoring the marking applied to the container. Alternatively, the monitoring device can, for example, also be provided separately downstream of the marking device and can also optionally be configured to monitor at least one further feature of the container in addition to the marking. For example, the monitoring device can also be configured as a second inspection device.

A second inspection device may, for example, also comprise a device for determining a property of an anti-friction coating of the container (in particular an anti-friction coating applied to the bottom of the container).

The transport device can, for example, be configured as a vacuum conveyor belt, in which the containers are held on the transport belt by negative pressure being applied and can thus be transported safely.

In one embodiment, it may be provided that each of the described devices for inspecting/monitoring at least one property of the container (i.e., each inspection device and the monitoring device, for example) is arranged on the module upstream of the discharge device.

The additional devices described can be arranged on the frame (on which the inspection device and the discharge device can be permanently arranged, in particular cannot be removed without tools, for example) for example detachably arranged by means of receiving or centering mandrels, screw connections and/or bayonet connections so that they can be optionally attached or removed if necessary.

The advantages of compactification can thus be applied to other devices.

The inspection device can comprise two inspection elements for inspecting containers, and the two inspection elements can be arranged on a common receptacle of the inspection device.

With this embodiment, the inspection device itself becomes even more compact, since different inspection tasks can be carried out substantially in the same place, which reduces the transport path that a container has to travel through the inspection device.

It may be provided that the inspection elements are configured and arranged on the common receptacle in such a way that the inspection elements can inspect a container from different directions.

The different directions can be located in particular in a plane, or in planes spaced apart from one another in the transport direction, perpendicularly to a direction in which the containers are transported through the inspection device in the region of the inspection elements.

It may be provided that the different directions enclose an angle of 75° to 105° with each other. Preferably, the angle can also be approximately 90°. This configuration allows for the most complete possible inspection of the containers.

According to another aspect of the invention, a container treatment machine for treating containers such as bottles, cans or the like is further provided, the container treatment machine comprising a module according to any one of the preceding embodiments. In this context, it may be provided that the module itself forms the container treatment machine or that further treatment modules (for example, another module according to the preceding embodiments) are arranged upstream or downstream (viewed in the transport direction of the containers through the container treatment machine) for treating the containers. The container treatment is not limited according to the invention, but can, for example, comprise filling, closing, labeling, printing, inspecting or similar processes.

It may be provided that the container treatment machine is an inspection machine or a modular empty can inspection machine. The use of a module according to one of the described embodiments is particularly advantageous in such machines.

### BRIEF DESCRIPTION OF THE DRAWING FIGURES

FIG. 1 shows an embodiment of a module.

FIG. 2 shows an embodiment of a common receptacle and inspection elements.

### DETAILED DESCRIPTION

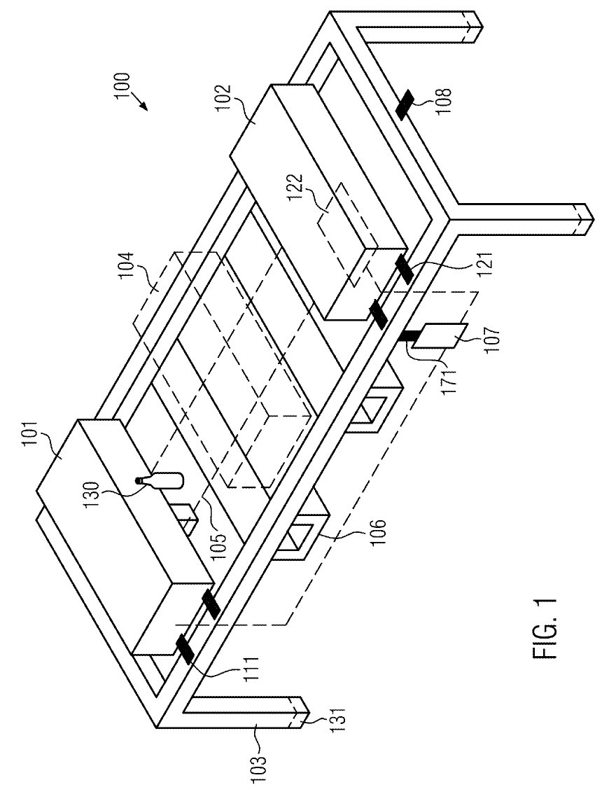

FIG. 1 shows an embodiment of a module 100 for a container treatment machine. The term module is understood in particular to mean a part of a container treatment machine which, in some embodiments, does not constitute the entire container treatment machine, but either exclusively or at least comprises the components described below.

The module 100 comprises a frame 103. This frame can be formed in one piece or multiple pieces. In the case of multi-piece construction, it can, for example, be formed from a plurality of tubes, such as metal tubes, assembled via screw connections, plug-in connections, click connections or the like. If the frame 103 is formed in one piece, at least one load-bearing structure may, for example, be formed from or comprise elements that are rigidly connected to one another, in particular elements that are non-detachably connected, such as welded tubes.

The material of the frame 103 is not limited in the sense of the invention. Regardless of whether the frame is made of one piece or in several parts, the frame can comprise further elements. These can be detachably connected to the one-piece or multi-part structure of the frame, for example by being screwed thereto or clicked thereinto.

The module 100 also comprises at least one inspection device 101 and one discharge device 102.

The inspection device 101 is configured to inspect containers such as cans, bottles, or the like. The inspection device may, for example, comprise one or more cameras or other sensors arranged one after the other in the transport direction, for example, configured to inspect the entire, or at least part of, the containers. Other devices, such as suitable optical systems for emitting light from a light source toward the containers, for example as diffuse lighting, may be provided as part of the inspection device. In this respect, the inspection device can be configured in any generally known way with regard to its functional configuration for inspecting containers.

The discharge device 102 is preferably arranged downstream of the inspection device 101 insofar as the inspection device and the discharge device interact with one another in such a way that properties (such as a defect, contamination or the like) identified by the inspection device with regard to any particular feature of the containers the discharge device is targetedly controlled in order to discharge these containers.

According to the invention, it can be provided that the inspection device and the discharge device are arranged on the frame in a well-defined position or in a well-defined relative arrangement (which is determined by each of the well-defined positions) to one another. A well-defined position is a position that the discharge device and the inspection device occupy after the module has been fully set up, for example by the manufacturer, i.e., in particular, the relative arrangement of the discharge device and the inspection device on the frame has been adjusted so that they can collectively perform the intended function as flawlessly as possible. The position then assumed by the inspection device and the discharge device defines a relative arrangement of the inspection device and the discharge device to one another or to the frame and shall be regarded in the following as the well-defined relative arrangement on the frame.

Fastening the inspection device and the discharge device may, for example, involve screwing or clamping the inspection device and the discharge device to the frame or parts of the frame. For example, the inspection device 101 can be permanently, but optionally detachably, connected to the frame via suitable connecting elements 111. The connecting elements may be, for example, corresponding connecting elements on the frame and the inspection device, such as slots on the frame or part of the frame and screws that can be guided, for example, through holes connected to the inspection device and/or the discharge device in order to be inserted into the slots in the frame and fastened therein or fixed thereto.

Other possibilities are also conceivable, such as clamping the inspection device and the discharge device, wherein the means for fastening the inspection device and the discharge device in the well-defined relative arrangement for the inspection device and the discharge device need not be identical. For example, it may be provided that the discharge device is fastened or connected to the frame via a first type of detachable or non-detachable connection, and the inspection device is fastened to the frame via a second type, with the first type and the second type differing. In particular, it may be provided that the discharge device is permanently connected to the frame or cannot be detached without damage, and that the inspection device is detachably connected to the frame without having to be damaged when disconnecting it from the frame. The reverse is also conceivable.

The frame can, as in the embodiment shown here, comprise at least one, preferably a plurality of, support elements 131. The support elements can be configured, for example, as feet or as parts of the frame's feet. In particular, the support elements can be configured so that their height or length is adjustable, and therefore the arrangement of the frame and thus of the entire module 100 can be adjusted. This ensures that, for example, even in an uneven workshop, the module can be positioned so that the inspection device and the discharge device are preferably level.

The support elements can be configured to be infinitely adjustable (for example in the form of a spindle) or preferably adjusted independently of one another in several stages.

The module may further comprise an electrical and/or electronic component 107, which is provided for controlling the inspection device and/or the discharge device. The electrical or electronic component may be, for example, a switching cabinet or simply a control unit, such as a computer comprising an associated processor and storage, configured to control at least one function of the inspection device and/or the discharge device. Alternatively or additionally, the electrical or electronic component can provide or comprise a power supply for the inspection device and/or the discharge device.

It may also be provided that the module comprises a plurality of electrical and/or electronic components. At least one of this plurality of electrical and/or electronic components can be assigned to the inspection device and at least one other electrical and/or electronic component can be assigned to the discharge device such that the function of the inspection device is at least partially controlled by one electrical and/or electronic component and the discharge device is controlled by the at least one other electrical and/or electronic component. Analogously to the embodiments described above, the arrangement of the electrical or electronic component in a well-defined relative arrangement on the frame is to be understood as meaning that, after the module has been set up, this component assumes a specific position in which it would also be arranged as normal operation of the module continues.

A suitable connecting element 171 can be provided for fastening the electrical and/or electronic component, which can be configured analogously to the embodiments described so far. It may be provided that only certain positions are provided on the frame for the electrical and/or electronic component or the electrical and/or electronic components and that no other way of fastening these components to the frame is possible. It may be provided that the positions provided are such that they allow for a fundamentally free arrangement of the inspection device and/or the discharge device, without the electrical and/or electronic component(s) hindering it. It may be provided that the electrical and/or electronic component is arranged on the frame in such a way that it is at least partially protected from contamination by splashing media, for example by being arranged on the underside of the frame.

The frame may alternatively or additionally also comprise one or more connecting elements 108 for connecting the frame to another component of the container treatment machine. In particular, it may be provided that the connecting element can be used to establish a connection to another frame, for example one also comprising an inspection device and a discharge device according to the embodiments described above. The connecting element can advantageously be configured in such a way that the connection to the other component of the container treatment machine is detachable such that, for example for the purpose of transporting the entire container treatment machine, it can be detached after initially setting up the entire container treatment machine and the modules can be individually transported to the customer, for example.

Alternatively or additionally, the frame can also comprise one or more transport receivers 106 which are configured to receive transport elements of a transport device. The transport device is a transport device that can transport the frame as a whole, preferably the entire module. The transport device can be, for example, a forklift, and the transport receivers can be receiving openings or receiving regions through which the forklift forks can be guided. Other embodiments are also conceivable, and in this respect the transport receivers are only limited in that they can interact with a suitable transport device. The entire structure of the transport receivers and their fastening, for example to the frame, can preferably be configured in such a way that they can bear the entire weight of the module. They can be detachably or even non-detachably connected to the frame, for example welded thereto.

In order to keep the size of the module (i.e., in particular the spatial dimensions of the module) as small as possible and thus ensure great flexibility in terms of the arrangement of various components of the container treatment machine, it may be provided that the module comprises only the inspection device 101 and the discharge device 102. However, it may also be provided that the module 101 comprises at least one further device 104, in particular another inspection device and/or another discharge device and/or a marking device for marking containers that have passed the inspection devices or that have passed the discharge device 102. The marking device may, for example, be a printing device, in particular a direct printing device, which can apply a marking to the outer surface of the container.

Alternatively or additionally, the module 100 can also comprise a transport device for transporting containers, for example from the inspection device 101 to the discharge device 102. In preferred embodiments, all of these devices are fastened to the frame in a well-defined arrangement, the term “well-defined arrangement” being understood in accordance with the preceding embodiments.

In a further embodiment, it can be provided that the frame may comprise a through-opening 122 for the passage of containers from the discharge device 102. The through-opening 122 can be arranged in a predefined position on or within the frame. Although adjustment of the position of the discharge device 102 relative to the position of this through-opening 122 may be necessary when setting up the module, in these embodiments this adjustment is preferably so small (for example, a few millimeters or a few centimeters in at least one direction) that the discharge device can in any case supply discharged containers to the through-opening. It may also be provided that a receptacle for discharged containers can be arranged in the region of the through-opening 122, in particular that it can be connected to the frame 103. Discharged containers can then be fed from the discharge device, through the through-opening 122 and into the receptacle, where they can then be stored.

Overall, the dimensions of the module, comprising all components and parts discussed in the previous embodiments, can be of such a size that the module, when fully assembled, has dimensions (length, height and width) that are one or at most equal to the dimensions of a standard ISO container so that the module can be housed in a standard ISO container and thus transported, for example from the manufacturer to the customer, in its assembled state.

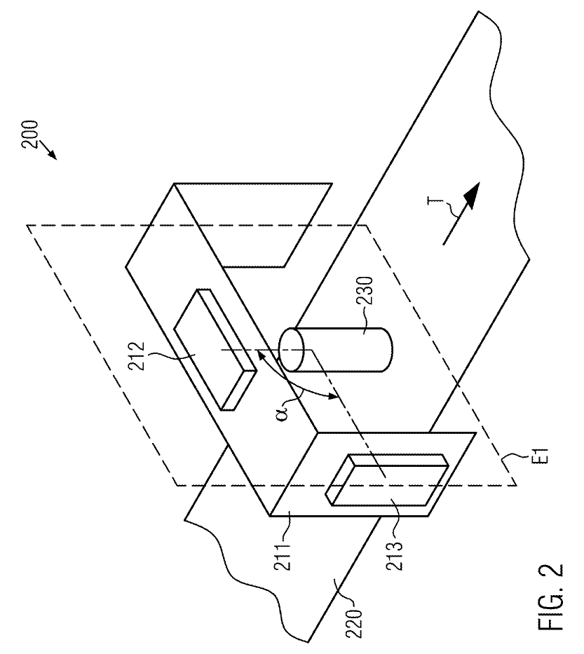

FIG. 2 shows a schematic representation of part of an inspection device that can be used in combination with all the embodiments of FIG. 1. The inspection device 200 is shown here in relation to a transport device 220, which can transport containers 230 in a transport direction T. The containers 230 can be, for example, cans, bottles, or the like.

In the embodiment shown here, the inspection device comprises at least two inspection elements 212 and 213. These are configured to inspect at least part of the containers 230. For example, the inspection elements 212 and 213 could be cameras.

In the embodiments shown in FIG. 2, the inspection elements 212 and 213 are arranged on a common receptacle so that the inspection elements can inspect the container 230 from different directions that enclose an angle α with one another. The directions can, for example, coincide with the optical axes of the optical system of a camera as an inspection element or generally indicate from which direction the inspection elements 212 and 213 can inspect the container.

The directions can, in principle, be arranged arbitrarily in space. However, embodiments in which the directions lie in a common plane E1, or define a plane E1 that can be perpendicular to a transport direction T of the containers in the transport device 220, are preferred. To ensure that the most complete inspection of the container possible is possible with the fewest possible inspection elements, it may be provided that the different directions enclose an angle α of between 75° and 105° with one another, in particular an angle of 90° with one another.

This allows the necessary extension of the inspection device in the transport direction T to be reduced, as it allows the containers to be inspected from different directions at the same point, when viewed in the transport direction T of the containers. The receptacle 211 can, for example, be configured as or comprise a frame to which the inspection elements can be detachably fastened via suitable connecting elements, such as screws or clamps. Instead of the two inspection elements shown here, more inspection elements for inspecting the containers can also be arranged on a receptacle 211. Alternatively, it can also be provided that the inspection device 200 comprises at least two receptacles, each comprising at least two inspection elements according to the embodiments described, wherein the direction from which at least one inspection element of a first receptacle inspects the containers is different from all of the directions from which the inspection elements of a second receptacle inspect the containers. This avoids certain regions of the containers being inspected twice (or at least the containers being inspected several times from the same direction), which further reduces the number of inspection elements and thus also the space required for the inspection device.

We claim:

1. A module for a container treatment machine, the module comprising:
a frame;
a container inspection device; and
a container discharge device downstream of the inspection device; wherein the inspection device and the discharge device are fastened to the frame in a well-defined relative arrangement.

2. The module according to claim 1, wherein the inspection device and/or the discharge device are permanently or detachably fastened to the frame.

3. The module according to claim 1, wherein the frame comprises support elements for placing down the module.

4. The module according to claim 1, wherein the frame comprises a through-opening for the passage of containers from the discharge device.

5. The module according to claim 1, wherein the module comprises an electrical or electronic component for controlling the inspection device and/or the discharge device.

6. The module according to claim 5, wherein the electrical or electronic component is fastened to the frame in a well-defined position.

7. The module according to claim 1, wherein the frame comprises a connecting element for connecting the frame to another component of the container treatment machine.

8. The module according to claim 7, wherein the connecting element is configured to adjust the arrangement of the module relative to the component.

9. The module according to claim 1, wherein the dimensions of the module allow the module to be transported in an ISO container.

10. The module according to claim 1, wherein the frame comprises transport receivers for receiving transport elements of a transport device.

11. The module according to claim 1, wherein the module comprises at least one of a second inspection device, a transport device for transporting containers, and a marking device for marking containers in a well-defined arrangement relative to the inspection device and/or to the discharge device.

12. The module according to claim 11, wherein the inspection device comprises two inspection elements for inspecting containers and wherein the two inspection elements are arranged on a common receptacle of the inspection device.

13. The module according to claim 12, wherein the inspection elements are configured and arranged on the common receptacle such that the inspection elements can inspect a container from different directions, wherein the different directions optionally enclose an angle of 75° to 105° with one another.

14. A container treatment machine for treating containers such as bottles, cans or the like, the container treatment machine comprising a module according to claim 1.

15. The container treatment machine according to claim 14, wherein the container treatment machine is an inspection machine or a modular empty can inspection machine.
